(19) United States
(12) Patent Application Publication
(10) Pub. No.: US 2020/0328031 A1
(43) Pub. Date: Oct. 15, 2020

(54) STACKED CAPACITOR ASSEMBLY STRUCTURE

(71) Applicant: ANDAQ TECHNOLOGY CO., LTD., Taipei City (TW)

(72) Inventor: CHIA-YU WU, NEW TAIPEI CITY (TW)

(21) Appl. No.: 16/684,705

(22) Filed: Nov. 15, 2019

(30) Foreign Application Priority Data
Apr. 15, 2019 (TW) 108113071

(51) Int. Cl. H01G 4/30; H01G 4/008; H01G 4/232; H01G 4/08

(52) U.S. Cl. CPC H01G 4/304; H01G 4/08; H01G 4/2325; H01G 4/008

(57) ABSTRACT

A stacked capacitor assembly structure includes a capacitor unit, a package unit, and an electrode unit. The capacitor unit includes a plurality of stacked capacitors, each of which has a positive part and a negative part. The package unit includes an insulating package body partially covering the capacitor unit, and the capacitor unit has a first portion and a second portion exposed from the package unit. The electrode unit includes a first electrode structure and a second electrode structure. Each of the stacked capacitors includes a metal foil, the surface of the metal foil includes a porous corrosion layer, and the porous corrosion layer is at least divided into a first porous corrosion region belonging to the positive part and a second porous corrosion region belonging to the negative part.

### CROSS-REFERENCE TO RELATED PATENT APPLICATION

This application claims the benefit of priority to Taiwan Patent Application No. 108113071, filed on Apr. 15, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a capacitor assembly structure, and more particularly to a stacked capacitor assembly structure.

### BACKGROUND OF THE DISCLOSURE

Capacitors have been widely used in consumer appliances, computer motherboards and their peripherals, power supplies, communication products, and automotive basic components and are considered one of the indispensable components in electronic products. The main functions of capacitors include: filtering, bypassing, rectification, coupling, decoupling, and (phase) shifting. Capacitors are available in different types depending on materials and applications, including aluminum electrolytic capacitors, tantalum electrolytic capacitors, multilayer ceramic capacitors, and film capacitors. Conventional solid electrolytic capacitors have the advantages of small size, large capacitance, superior frequency characteristics, and the like, and can be used to decouple the power supply circuit for the central processing unit.

In general, a stack of a plurality of capacitor units can be utilized to form a high-capacity solid electrolytic capacitor. A stacked solid electrolytic capacitor of the related art includes a plurality of capacitor units and a lead frame, and each capacitor unit includes an anode portion, a cathode portion and an insulating portion, and the insulating portion electrically insulates the anode portion from the cathode portion. In particular, the cathode portions of the capacitor units are stacked on each other, and the plurality of capacitor units are electrically connected to each other by providing a conductor layer between adjacent capacitor units. However, stacked capacitors of the related art still have issues to be improved.

### SUMMARY OF THE DISCLOSURE

In response to the above-referenced technical inadequacies, the present disclosure provides a stacked capacitor assembly structure.

In one aspect, the present disclosure provides a stacked capacitor assembly structure including: a capacitor unit, a package unit, and an electrode unit. The capacitor unit includes a plurality of stacked capacitors, each of which has a positive part and a negative part. The package unit includes an insulating package body partially covering the capacitor unit, and the capacitor unit has a first portion and a second portion exposed from the package unit. The electrode unit includes a first electrode structure and a second electrode structure. Each of the stacked capacitors includes a metal foil, the surface of the metal foil includes a porous corrosion layer, and the porous corrosion layer is at least divided into a first porous corrosion region belonging to the positive part and a second porous corrosion region belonging to the negative part. The capacitor unit includes a plurality of insulating fillers, each of which is surroundingly filled around the corresponding first porous corrosion region to block moisture from passing through the first porous corrosion region.

In one aspect, the present disclosure provides a stacked capacitor assembly structure including: a capacitor unit, a package unit, and an electrode unit. The capacitor unit includes a plurality of stacked capacitors, each of which has a positive part and a negative part. The package unit includes an insulating package body partially covering the capacitor unit. The electrode unit includes a first electrode structure and a second electrode structure. Each of the stacked capacitors includes a metal foil, the surface of the metal foil includes a porous corrosion layer, and the porous corrosion layer is at least divided into a first porous corrosion region belonging to the positive part and a second porous corrosion region belonging to the negative part. The capacitor unit includes a plurality of insulating fillers, each of which is surroundingly filled around the corresponding first porous corrosion region.

In one aspect, the present disclosure provides a stacked capacitor assembly structure including: a capacitor unit and an electrode unit. The capacitor unit includes a plurality of stacked capacitors, each of which has a positive part and a negative part. The electrode unit includes a first electrode structure and a second electrode structure. Each of the stacked capacitors includes a metal foil, the surface of the metal foil includes a porous corrosion layer, and the porous corrosion layer is at least divided into a first porous corrosion region belonging to the positive part and a second porous corrosion region belonging to the negative part. The capacitor unit includes a plurality of insulating fillers, each of which is surroundingly filled around the corresponding first porous corrosion region.

Therefore, one of the beneficial effects of the present disclosure is that, by the technical features of “each of the stacked capacitors including a metal foil, the surface of the metal foil including a porous corrosion layer, and the porous corrosion layer being at least divided into a first porous corrosion region belonging to the positive part and a second porous corrosion region belonging to the negative part” and “capacitor unit including the plurality of insulating fillers, each of which being surroundingly filled around the corresponding first porous corrosion region,” moisture can be blocked from passing through the first porous corrosion region.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a cross-sectional view of a stacked capacitor assembly structure according to a first embodiment of the present disclosure.

FIG. 2 is a cross-sectional view of the stacked capacitor assembly structure according to the first embodiment of the present disclosure.

FIG. 3 is an enlarged schematic view of a portion III of FIG. 1.

FIG. 4 is an enlarged schematic view of a portion III of FIG. 1.

FIG. 5 is a side schematic view of the stacked capacitor assembly structure according to the first embodiment of the present disclosure.

FIG. 6 is a side schematic view of the stacked capacitor assembly structure according to a second embodiment of the present disclosure.

FIG. 7 is a fragmentary side schematic view of the stacked capacitor assembly structure according to a third embodiment of the present disclosure.

FIG. 8 is a side schematic view of the stacked capacitor assembly structure according to a fourth embodiment of the present disclosure.

FIG. 9 is a side schematic view of the stacked capacitor assembly structure according to a fifth embodiment of the present disclosure.

FIG. 10 is a side schematic view of the stacked capacitor assembly structure according to a sixth embodiment of the present disclosure.

FIG. 11 is a side schematic view of the stacked capacitor assembly structure according to a seventh embodiment of the present disclosure.

FIG. 12 is a side schematic view of the stacked capacitor assembly structure according to an eighth embodiment of the present disclosure.

FIG. 13 is a side schematic view of the stacked capacitor assembly structure according to a ninth embodiment of the present disclosure.

FIG. 14 is a side schematic view of the stacked capacitor assembly structure according to a tenth embodiment of the present disclosure.

FIG. 15 is a side schematic view of the stacked capacitor assembly structure according to an eleventh embodiment of the present disclosure.

FIG. 16 is a side schematic view of the stacked capacitor assembly structure according to a twelfth embodiment of the present disclosure.

FIG. 17 is a side schematic view of the stacked capacitor assembly structure according to a thirteenth embodiment of the present disclosure.

FIG. 18 is a side schematic view of the stacked capacitor assembly structure according to a fourteenth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

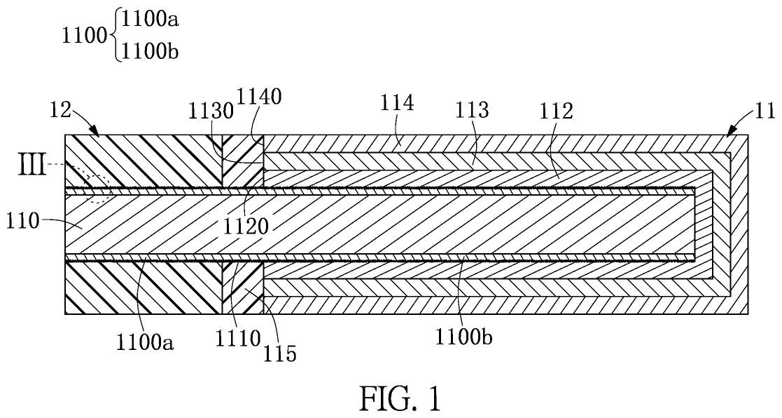

Referring to FIG. 1 to FIG. 5, a first embodiment of the present disclosure provides a stacked capacitor assembly structure Z, including: a capacitor unit 1, a package unit 2, and an electrode unit 3. For example, the stacked capacitor assembly structure Z can be a stacked capacitor package structure, a component type stacked capacitor component, or a stacked solid electrolytic capacitor defined by type of use.

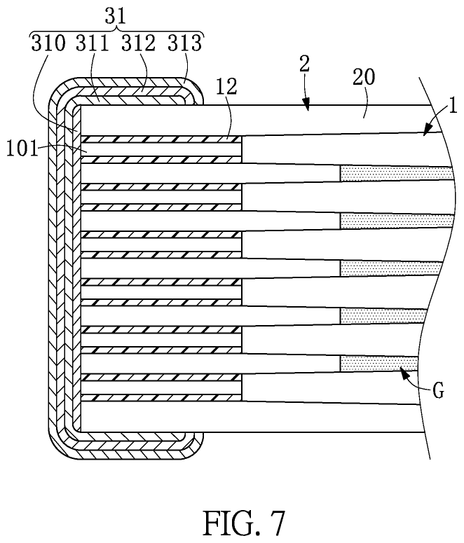

Firstly, the capacitor unit 1 includes a plurality of stacked capacitors 11, and each of the stacked capacitors 11 has a positive part P and a negative part N. Further, the plurality of stacked capacitors 11 are sequentially stacked, and each of the two stacked capacitors 11 can be electrically connected to each other through the conductive adhesive G, and the plurality of positive part P of the plurality of stacked capacitors 11 are separated from each other without contact. For example, as shown in FIG. 7, each of the stacked capacitors 11 includes a valve metal foil 110, an oxide layer 111 completely covering the metal foil 110, a conductive polymer composite layer 112 covering a portion of the oxide layer 111, a carbon adhesive layer 113 completely covering the conductive polymer composite layer 112, and a silver adhesive layer 114 completely covering the carbon adhesive layer 113. The oxide layer 111 is formed on the outer surface of the metal foil 110 to completely cover the metal foil 110. The metal foil 110 may be aluminum, copper or any metal material according to different usage requirements, and the surface of the metal foil 110 has a porous corrosion layer 1100, so that the metal foil 110 may be a corrosion foil having a porous corrosion layer 1100. When the metal foil 110 is oxidized, the oxide layer 111 is formed on the surface of the metal foil 110, and the metal foil 110 having the oxide layer 111 formed on the surface may be referred to as a valve metal foil. The porous corrosion layer 1100 is at least divided into a first porous corrosion region 1100a belonging to the positive part P of the stacked capacitor 11, and a second porous corrosion region 1100b belonging to the negative part N of the stacked capacitor 11.

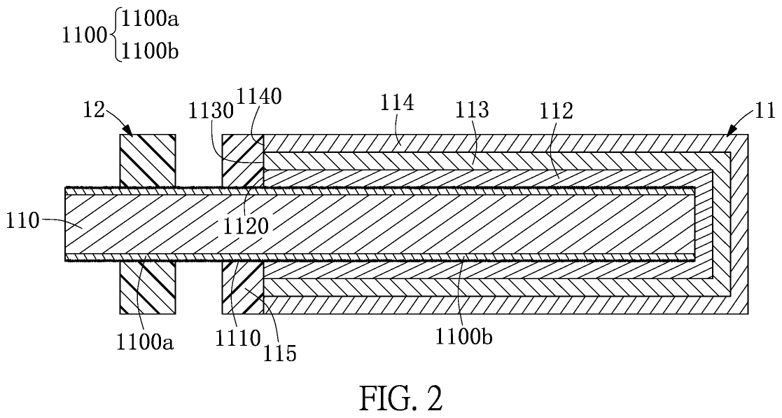

Furthermore, as shown in FIG. 1 and FIG. 2, each of the stacked capacitors 11 further includes an insulating layer 115 disposed on the outer surface of the oxide layer 111 and surrounding the oxide layer 111, and a length of the conductive polymer composite layer 112 of the stacked capacitor 11, a length of the carbon adhesive layer 113, and a length of the silver adhesive layer 114 are all limited by the insulating layer 115. The second porous corrosion region 1100b covers regions of the negative part N and the insulating layer 115. Further, the oxide layer 111 has a surrounding area 1110 on the outer surface thereof, and the insulating layer 115 of the stacked capacitor 11 is surroundingly disposed around the surrounding area 1110 of the oxide layer 111 and simultaneously contacts the end 1120 of the conductive polymer composite layer 112, the end 1130 of the carbon adhesive layer 113, and the end 1140 of the silver adhesive layer 114. However, the stacked capacitor 11 used in the present disclosure is not limited thereto.

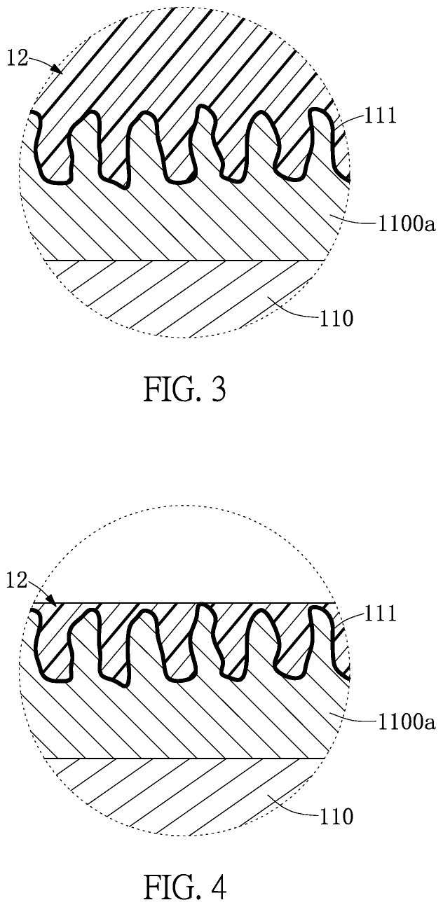

Further, the capacitor unit 1 further includes a plurality of insulating fillers 12, each of which is filled around the corresponding first porous corrosion region 1100a. For example, the insulating filler 12 is surroundingly formed around an outer surface of the oxide layer 111 of the first porous corrosion region 1100a and between the first portion 101 and the negative part N of the stacked capacitor 11 to block moisture from passing through the first porous corrosion region 1100a. The insulating filler 12 can be covered between the first portion 101 and the negative part N of the stacked capacitor 11 (as shown in FIG. 1), or may surround only part of the first porous corrosion region 1100a (shown in FIG. 2). Further, the insulating filler 12 may be a type having a certain thickness and surrounding the first porous corrosion region 1100a (as shown in FIG. 3), or may only be a type filled into the pores of the first porous corrosion region 1100a (as shown in FIG. 4). Further, the insulating filler 12 can be an insulating layer made of any insulating material such as epoxy, phenol resin or silicon. However, the present disclosure is not limited thereto.

In addition, the stacked capacitor 11 may also include a metal foil, an oxide layer, a conductive polymer layer, a carbon adhesive layer, and a silver adhesive layer. For example, the oxide layer is formed on the outer surface of the metal foil to completely cover the metal foil. The conductive polymer layer is formed on the oxide layer to partially cover the oxide layer. The carbon adhesive layer is formed on the conductive polymer layer to cover the conductive polymer layer. The silver adhesive layer is formed on the carbon adhesive layer to cover the conductive polymer layer. According to different use requirements, the metal foil may be aluminum, copper or any metal material, and the surface of the metal foil has a porous corrosion layer, so that the metal foil may be a corrosion foil with a porous corrosion layer. When the metal foil is oxidized, an oxide layer is formed on the surface of the metal foil, and the metal foil on which the oxide layer is formed may be referred to as a valve metal foil. However, the present disclosure is not limited thereto.

Further, the stacked capacitor 11 may further include a surrounding barrier layer, and the surrounding barrier layer is surroundingly formed on an outer surface of the oxide layer. For example, the distance of an outer peripheral surface of the surrounding barrier layer relative to the oxide layer may be greater than, less than, or equal to the distance of an outer peripheral surface of the silver adhesive layer relative to the oxide layer. In addition, an end of the conductive polymer layer, an end of the carbon adhesive layer, and an end of the silver adhesive layer contact or separate the surrounding barrier layer so that the length of the conductive polymer layer, the length of the carbon adhesive layer, and the length of the silver adhesive layer are all limited by the surrounding barrier layer. In addition, according to different usage requirements, the surrounding barrier layer can be an insulating layer made of any insulating material such as epoxy or silicon. It is worth noting that the stacked capacitor 11 may not use a surrounding barrier layer depending on different usage requirements. However, the present disclosure is not limited thereto.

Furthermore, the package unit 2 includes an insulating package body 20 partially covering the capacitor unit 1, and the capacitor unit 1 has a first portion 101 and a second portion 102 exposed from the package unit 2. That is, the first portion 101 and the second portion 102 of each of the stacked capacitors 11 are exposed by the insulating package body 20 without being covered. For example, the insulating package body 20 can be made of any insulating material such as epoxy or silicon. However, the present disclosure is not limited thereto.

Further, the electrode unit 3 includes a first electrode structure 31 and a second electrode structure 32. Furthermore, the first electrode structure 31 can serve as a “first outer end electrode” to cover the first portion 101 of the capacitor unit 1 and electrically contact the positive part P of the stacked capacitor 11. In addition, the second electrode structure 32 can serve as a “second outer end electrode” to cover the second portion 102 of the capacitor unit 1 and electrically contact the negative part N of the stacked capacitor 11. In other words, the first electrode structure 31 can serve as an outer end electrode to cover one end of the capacitor unit 1 and electrically contact one of the positive part P and the negative part N of the stacked capacitor 11, and the second electrode structure 32 can serve as the other outer end electrode to cover the other side end of the capacitor unit 1 and electrically contact the other of the positive part P and the negative part N of the stacked capacitor 11.

Thereby, the first electrode structure 31 as the first outer end electrode and the second electrode structure 32 as the second outer end electrode can be used to cover the first portion 101 and the second portion 102 of the stacked capacitor 11, respectively (that is, the first electrode structure 31 and the second electrode structure 32 do not need to be inserted into the interior of the insulating package body 20 like electrode pins of a lead frame). Therefore, the first electrode structure 31 and the second electrode structure 32 of the electrode unit 3 can be quickly formed on opposite side ends of the insulating package body 20 without performing any bending step (step of bending the electrode pins of the lead frame), so as to effectively improve a productivity of the stacked capacitor assembly structure Z.

### Second Embodiment

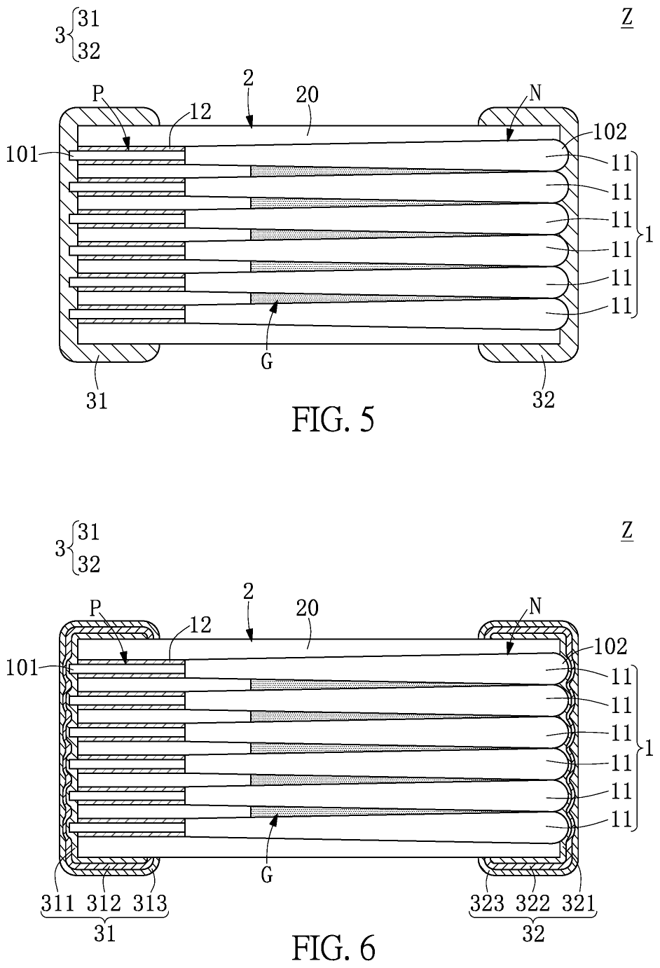

Referring to FIG. 6, a second embodiment of the present disclosure provides a stacked capacitor assembly structure Z, including: a capacitor unit 1, a package unit 2, and an electrode unit 3. Comparing FIG. 6 with FIG. 5, the greatest difference between the second embodiment and the first embodiment of the present disclosure is that, in the second embodiment, the first electrode structure 31 includes a first inner conductive layer 311 covering the first portion 101 and electrically contacting a positive part P, a first intermediate conductive layer 312 covering the first inner conductive layer 311, and a first outer conductive layer 313 covering the first intermediate conductive layer 312. In addition, a second electrode structure 32 includes a second inner conductive layer 321 covering a second portion 102 and electrically contacting a negative part N, a second intermediate conductive layer 322 covering the second inner conductive layer 321, and a second outer conductive layer 323 covering the second intermediate conductive layer 322.

For example, the first inner conductive layer 311 and the second inner conductive layer 321 may both include an Ag layer (or other conductive material similar to Ag) or a composite layer including an Ag layer and a conductive diffusion barrier layer. The first intermediate conductive layer 312 and the second intermediate conductive layer 322 may both be Ni layers or other conductive materials similar to Ni, and the first outer conductive layer 313 and the second outer conductive layer 323 may both be Sn layers or other conductive materials similar to Sn. In addition, the conductive diffusion barrier layer is selected from a combination of carbon (C), carbon compounds, carbon nanotubes, graphene, silver (Ag), gold (Au), platinum (Pt), palladium (Pb), titanium nitride (TiNx), titanium carbide (TiC), and other antioxidant materials; however, the present disclosure is not limited thereto. By the conductive diffusion barrier layer, external moisture cannot pass through the electrode unit 3 and enter the capacitor unit 1, thereby improving airtightness and weather resistance of the stacked capacitor assembly structure Z. However, the present disclosure is not limited thereto.

### Third Embodiment

Referring to FIG. 7, a third embodiment of the present disclosure provides a stacked capacitor assembly structure Z, including: a capacitor unit 1, a package unit 2, and an electrode unit 3. Comparing FIG. 7 with FIG. 6, the greatest difference between the third embodiment and the second embodiment of the present disclosure is that, in the third embodiment, a first electrode structure 31 includes a conductive water resistance layer 310 connected to a plurality of positive parts P and a plurality of conductive water resistance layers 310 of the insulating filler 12. The conductive water resistance layer 310 is made of a metal material or a metal compound, the metal material being gold (Au), silver (Ag), platinum (Pt), palladium (Pd), titanium (Ti), nickel (Ni), chromium (Cr), zinc (Zn) or brass (Ms), and the metal compound is Ni—Cr, TiW, titanium nitride (TiNx), titanium carbide (TiC), titanium oxide (TiOx), titanium oxynitride (Ti(Ti(O,N)x), titanium oxynitride (Ti(O,C)x), titanium oxynitride (Ti(C,N)x) or titanium oxynitride (Ti(O,N,C)x).

For example, the first electrode structure 31 may further include the conductive water resistance layer 310 formed on the contact surface of the first electrode structure 31, the plurality of positive parts P and the plurality of insulating fillers 12. Further, the conductive water resistance layer 310 is formed by sputtering to cover and shield the plurality of positive part P and the plurality of insulating fillers 12. Since the conductive water resistance layer 310 is formed by sputtering, the conductive water resistance layer 310 covers a plurality of positive part P and a plurality of insulating fillers 12 with a coverage of 100%, the coverage area can be free of any pores, and effectively prevents external moisture and oxygen from entering the capacitor unit 1 through the electrode unit 3, thereby achieving the effect of blocking water and blocking oxygen. Thereby, the airtightness and weather resistance of the stacked capacitor assembly structure Z can be improved. However, the present disclosure is not limited thereto.

### Fourth Embodiment

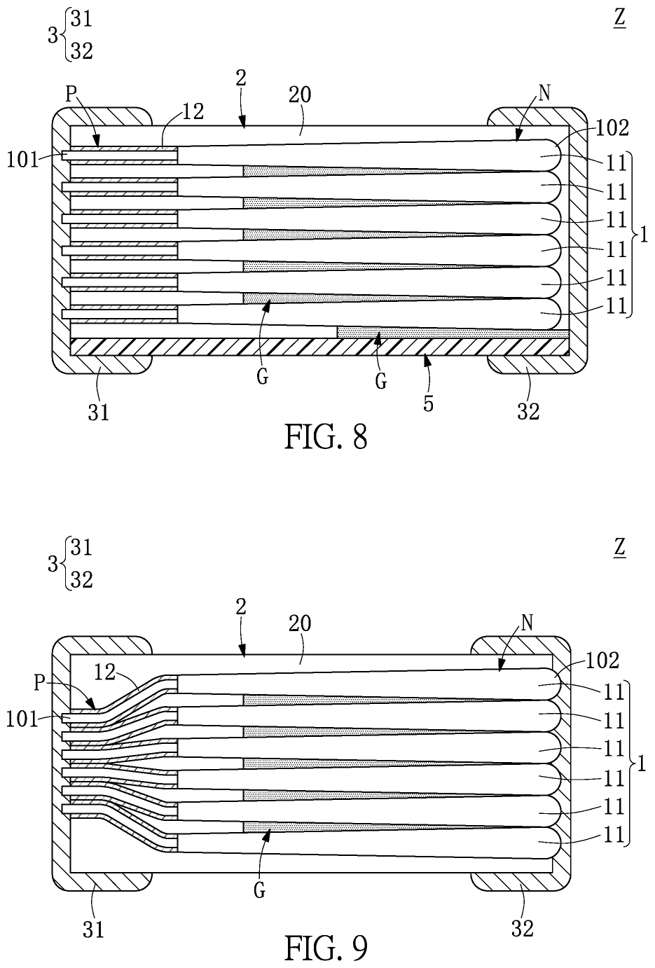

Referring to FIG. 8, a fourth embodiment of the present disclosure provides a stacked capacitor assembly structure Z, including: a capacitor unit 1, a package unit 2, and an electrode unit 3. Comparing FIG. 8 with FIG. 5, the greatest difference between the fourth embodiment and the third embodiment of the present disclosure is that, in the fourth embodiment, the stacked capacitor assembly structure Z may further include an insulating substrate 5 disposed between a first electrode structure 31 and a second electrode structure 32, and a portion of the upper surface of an insulating substrate 5 is coated with a conductive adhesive G. The insulting substrate can be either organic or inorganic, for example, SiO₂, Al₂O₃, Epoxy Molding Compound, FR4, FR5, and Polyimide. Moreover, a plurality of stacked capacitors 11 can be sequentially stacked on a first support member 41, and a negative part N of the stacked capacitor 11 can be electrically connected to the second electrode structure 32 through the conductive adhesive G. In other words, the plurality of stacked capacitors 11 of the fourth embodiment can be supported in advance by the insulating substrate 5 to facilitate subsequent processing. However, the present disclosure is not limited thereto.

It should be noted that the first electrode structure 31 and the second electrode structure 32 of the electrode unit 3 of the fourth embodiment may be replaced with the first electrode structure 31 and the second electrode structure 32 of the same electrode unit 3 as the second embodiment.

### Fifth Embodiment

Referring to FIG. 9, a fifth embodiment of the present disclosure provides a stacked capacitor assembly structure Z, including: a capacitor unit 1, a package unit 2, and an electrode unit 3. Comparing FIG. 9 with FIG. 5, the greatest difference between the fifth embodiment and the first embodiment of the present disclosure is that, in the fifth embodiment, a plurality of positive parts P of a plurality of stacked capacitors 11 are sequentially stacked. For example, a plurality of positive parts P may be sequentially stacked by laser welding, impedance welding, or other types of welding, however the present disclosure is not limited thereto.

It should be noted that the first electrode structure 31 and the second electrode structure 32 of the electrode unit 3 of the fifth embodiment may be replaced with the first electrode structure 31 and the second electrode structure 32 of the same electrode unit 3 as the second embodiment.

### Sixth Embodiment

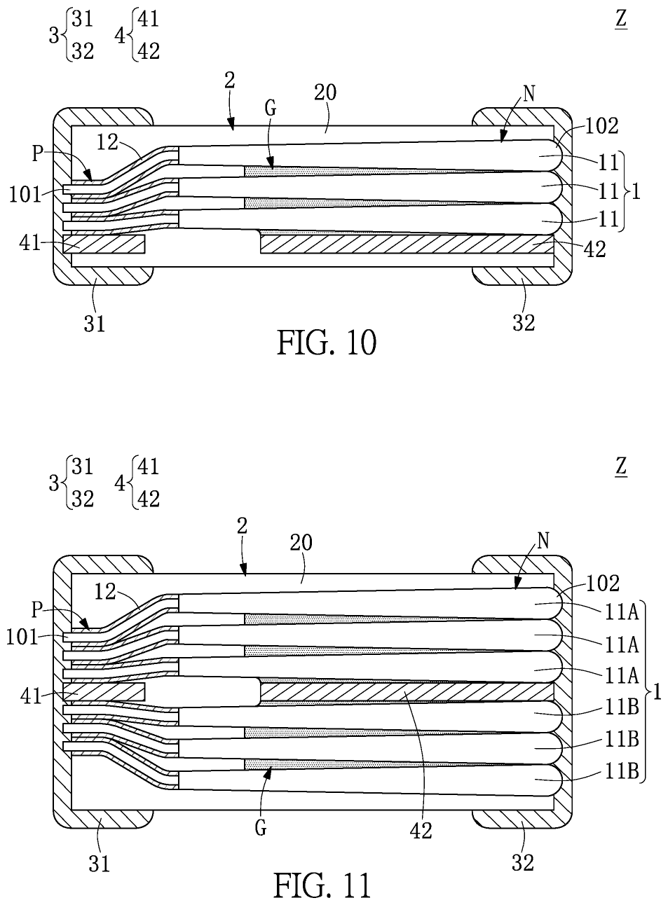

Referring to FIG. 10, a sixth embodiment of the present disclosure provides a stacked capacitor assembly structure Z, including: a capacitor unit 1, a package unit 2, and an electrode unit 3. Comparing FIG. 10 with FIG. 9, the greatest difference between the sixth embodiment and the fifth embodiment of the present disclosure is that, in the sixth embodiment, the stacked capacitor assembly structure Z of the sixth embodiment further includes a support unit 4. The support unit 4 includes a first support member 41 and a second support member 42. In addition, a plurality of stacked capacitors 11 can be sequentially stacked on the first support member 41 and the second support member 42, and a positive part P and a negative part N of the stacked capacitor 11 can be electrically connected to the first support member 41 and the second support member 42, respectively. In other words, the plurality of stacked capacitors 11 of the sixth embodiment can be supported in advance by the first support member 41 and the second support member 42, which is advantageous for subsequent processing.

It should be noted that the first electrode structure 31 and the second electrode structure 32 of the electrode unit 3 of the sixth embodiment may be replaced with the first electrode structure 31 and the second electrode structure 32 of the same electrode unit 3 as the second embodiment.

### Seventh Embodiment

Referring to FIG. 11, a seventh embodiment of the present disclosure provides a stacked capacitor assembly structure Z, including: a capacitor unit 1, a package unit 2, and an electrode unit 3. Comparing FIG. 11 with FIG. 20, the greatest difference between the seventh sixth embodiment and the sixth embodiment of the present disclosure is that, in the seventh embodiment, a plurality of stacked capacitors can be divided into a plurality of first stacked capacitors 11A and a plurality of second stacked capacitors 11B. Furthermore, the plurality of first stacked capacitors 11A can be sequentially stacked on the top end of a first support member 41 and a top end of the second support member 42, and the plurality of second stacked capacitors 11B can be sequentially stacked on a bottom end of the first support member 41 and a bottom end of the second support member 42. In other words, the plurality of first stacked capacitors 11A and the plurality of the second stacked capacitors 11B of the seventh embodiment can be supported by the first support member 41 and the second support member 42 in advance, which is advantageous for subsequent processing. However, the present disclosure is not limited thereto.

It should be noted that the first electrode structure 31 and the second electrode structure 32 of the electrode unit 3 of the seventh embodiment may be replaced with the first electrode structure 31 and the second electrode structure 32 of the same electrode unit 3 as the second embodiment.

### Eighth Embodiment

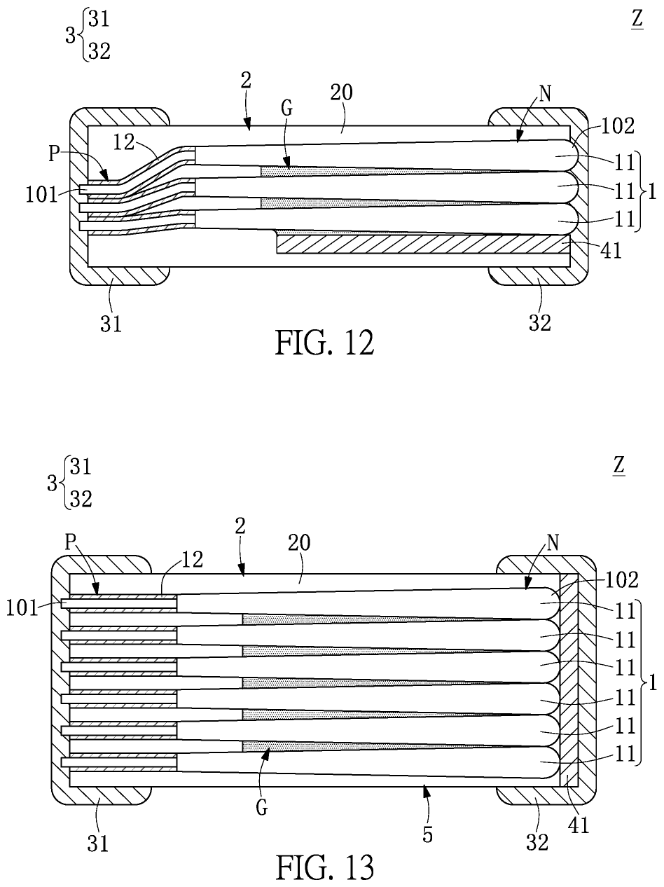

Referring to FIG. 12, an eighth embodiment of the present disclosure provides a stacked capacitor assembly structure Z, including: a capacitor unit 1, a package unit 2, and an electrode unit 3. Comparing FIG. 12 with FIG. 10, the greatest difference between the eighth embodiment and the sixth embodiment of the present disclosure is that, in the eighth embodiment, a plurality of stacked capacitors 11 can be sequentially stacked on a first support member 41, and a negative part N of one of the stacked capacitors 11 can be electrically connected to the first support member 41. In other words, the plurality of stacked capacitors 11 of the eighth embodiment can be supported in advance by the first support member 41, which is advantageous for subsequent processing. However, the present disclosure is not limited thereto.

It should be noted that the first electrode structure 31 and the second electrode structure 32 of the electrode unit 3 of the eighth embodiment may be replaced with the first electrode structure 31 and the second electrode structure 32 of the same electrode unit 3 as the second embodiment.

### Ninth Embodiment

Referring to FIG. 13, a ninth embodiment of the present disclosure provides a stacked capacitor assembly structure Z, including: a capacitor unit 1, a package unit 2, and an electrode unit 3. Comparing FIG. 13 with FIG. 12, the greatest difference between the ninth embodiment and the eighth embodiment of the present disclosure is that, in the ninth embodiment, a first support member 41 can serve as a “lead frame electrode pin” and can be disposed between a negative part N and a second electrode structure 32 of a plurality of stacked capacitors 11. Moreover, the first support member 41 is electrically connected to the negative part N and the second electrode structure 32 of the plurality of stacked capacitors 11. However, the present disclosure is not limited thereto.

It should be noted that the first electrode structure 31 and the second electrode structure 32 of the electrode unit 3 of the ninth embodiment may be replaced with the first electrode structure 31 and the second electrode structure 32 of the same electrode unit 3 as the second embodiment.

### Tenth Embodiment

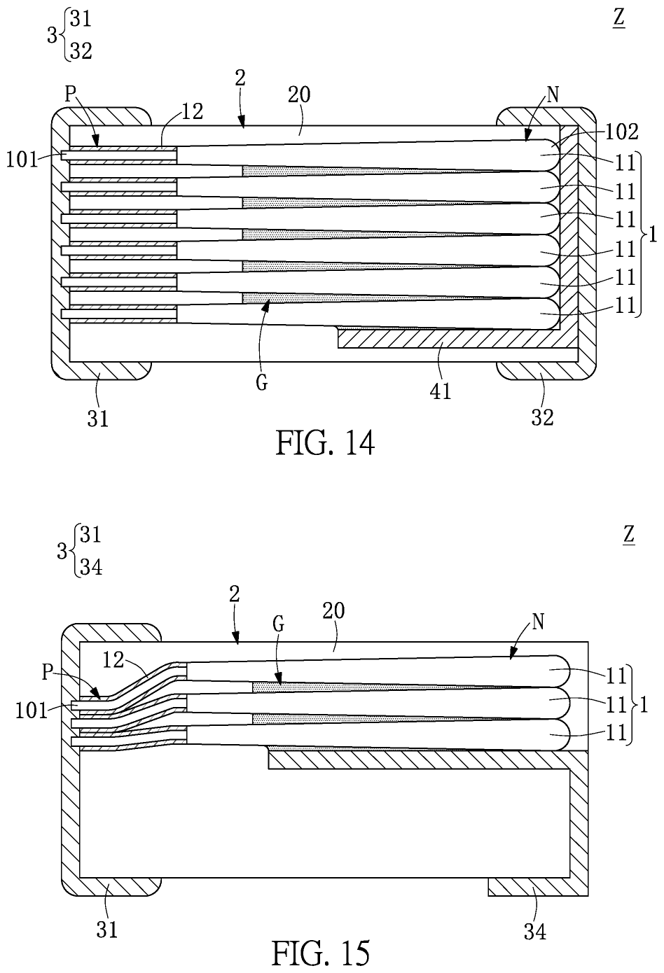

Referring to FIG. 14, a tenth embodiment of the present disclosure provides a stacked capacitor assembly structure Z, including: a capacitor unit 1, a package unit 2, and an electrode unit 3. Comparing FIG. 14 with FIG. 13, the greatest difference between the tenth embodiment and the ninth embodiment of the present disclosure is that, in the tenth embodiment, one end of a first support member 41 is bendable and extends in a direction toward a positive part P of a stacked capacitor 11. Therefore, the plurality of stacked capacitors 11 can also be supported by the first support member 41 in advance. However, the present disclosure is not limited thereto.

It should be noted that the first electrode structure 31 and the second electrode structure 32 of the electrode unit 3 of the tenth embodiment may be replaced with the first electrode structure 31 and the second electrode structure 32 of the same electrode unit 3 as the second embodiment.

### Eleventh Embodiment

Referring to FIG. 15, an eleventh embodiment of the present disclosure provides a stacked capacitor assembly structure Z, including: a capacitor unit 1, a package unit 2, and an electrode unit 3. The capacitor unit 1 includes a plurality of stacked capacitors 11, and each of the stacked capacitors 11 has a positive part P and a negative part N. The package unit 2 includes an insulating package body 20 partially covering the capacitor unit 1, and the electrode unit 3 includes a first electrode structure 31 and a second electrode structure 34.

As can be seen from the comparison between FIG. 15 and FIG. 11, the greatest difference between the tenth embodiment and the ninth embodiment of the present disclosure is that, in the eleventh embodiment, a first electrode structure 31 can be used as an “outer end electrode” to cover an exposed portion of the capacitor unit 1 (that is, a first portion 101) and electrically contacts a positive part P of the stacked capacitor 11. In addition, the second electrode structure 34 can serve as a “lead frame electrode pin” to support the capacitor unit 1 and electrically contact the negative part N of the stacked capacitor 11. In other words, the first electrode structure 31 can serve as an outer end electrode to cover one end of the capacitor unit 1 and electrically contact the positive part P of the stacked capacitor 11, and the second electrode structure 34 is electrically connected to the negative part N of the stacked capacitor 11. Furthermore, the plurality of positive part P of the plurality of stacked capacitors 11 are sequentially stacked on the lead frame electrode pin (i.e., the second electrode structure 34).

Thereby, the first electrode structure 31 as an outer terminal electrode can be used to cover the first portion 101 of the stacked capacitor 11 (that is, the first electrode structure 31 does not need to be inserted into an interior of the insulating package body 20 like electrode pins of the lead frame), so that the first electrode structure 31 of the electrode unit 3 can be quickly formed on the side end portion of the insulating package body 20 without performing any bending step (step of bending the electrode pins of the lead frame). Thereby, a production efficiency of the stacked capacitor assembly structure Z is effectively improved. However, the present disclosure is not limited thereto.

It should be noted that the first electrode structure 31 of the electrode unit 3 of the eleventh embodiment may be replaced with the first electrode structure 31 of the same electrode unit 3 as the second embodiment.

### Twelfth Embodiment

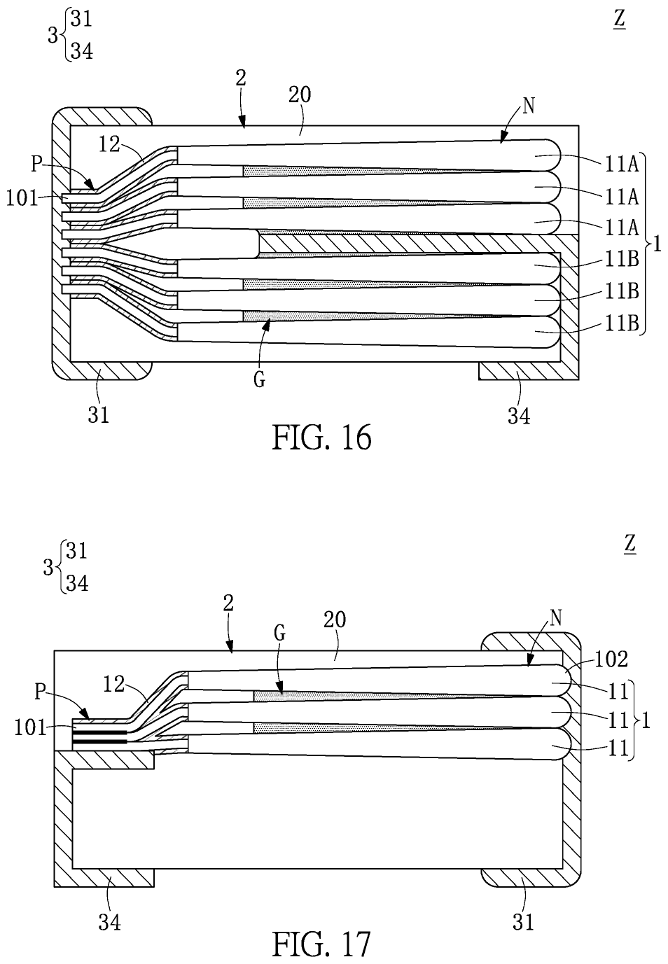

Referring to FIG. 16, a twelfth embodiment of the present disclosure provides a stacked capacitor assembly structure Z, including: a capacitor unit 1, a package unit 2, and an electrode unit 3. Comparing FIG. 16 with FIG. 15, the greatest difference between the twelfth embodiment and the eleventh embodiment of the present disclosure is that, in the twelfth embodiment, a plurality of stacked capacitors can be divided into a plurality of first stacked capacitors 11A and a plurality of second stacked capacitors 11B. In addition, a plurality of positive part P of the plurality of first stacked capacitors 11A are sequentially stacked on a top end of a lead frame electrode pins (that is, on a top end of a buried portion of the second electrode structure 34), and the plurality of positive parts P of the plurality of second stacked capacitors 11B are sequentially stacked on a bottom end of the lead frame electrode pins (that is, on a bottom end of the buried portion of the second electrode structure 34). However, the present disclosure is not limited thereto.

It should be noted that the first electrode structure 31 of the electrode unit 3 of the twelfth embodiment may be replaced with the first electrode structure 31 of the same electrode unit 3 as the second embodiment.

### Thirteenth Embodiment

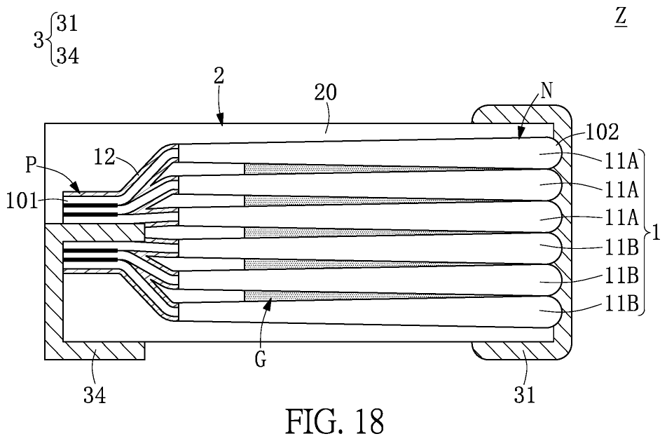

Referring to FIG. 17, a thirteenth embodiment of the present disclosure provides a stacked capacitor assembly structure Z, including: a capacitor unit 1, a package unit 2, and an electrode unit 3. As can be seen from the comparison between FIG. 17 and FIG. 15, the greatest difference between the thirteenth embodiment and the eleventh embodiment of the present disclosure is that, in the thirteenth embodiment, a first electrode structure 31 can be used as an “outer end electrode” to cover an exposed portion of the capacitor unit 1 (that is, a second portion 102) and electrically contacts a negative part N of the stacked capacitor 11. In addition, the second electrode structure 34 can serve as a “lead frame electrode pin” to support the capacitor unit 1 and electrically contact the positive part P of the stacked capacitor 11. In other words, the first electrode structure 31 can serve as an outer end electrode to cover one end of the capacitor unit 1 and electrically contact the negative part N of the stacked capacitor 11, and the second electrode structure 34 is electrically connected to the positive part P of the stacked capacitor 11.

Thereby, the first electrode structure 31 as an outer terminal electrode can be used to cover the second portion 102 of the stacked capacitor 11 (that is, the first electrode structure 31 does not need to be inserted into an interior of the insulating package body 20 like electrode pins of the lead frame), so that the first electrode structure 31 of the electrode unit 3 can be quickly formed on the side end portion of the insulating package body 20 without performing any bending step (step of bending the electrode pins of the lead frame). Thereby, a production efficiency of the stacked capacitor assembly structure Z is effectively improved. However, the present disclosure is not limited thereto.

It should be noted that the first electrode structure 31 of the electrode unit 3 of the thirteenth embodiment may be replaced with the first electrode structure 31 of the same electrode unit 3 as the second embodiment.

### Fourteenth Embodiment

Referring to FIG. 18, a fourteenth embodiment of the present disclosure provides a stacked capacitor assembly structure Z, including: a capacitor unit 1, a package unit 2, and an electrode unit 3. As can be seen from the comparison between FIG. 18 and FIG. 17, the greatest difference between the fourteenth embodiment and the thirteenth embodiment of the present disclosure is that, in the fourteenth embodiment, a plurality of stacked capacitors can be divided into a plurality of first stacked capacitors 11A and a plurality of second stacked capacitors 11B. In addition, a plurality of positive part P of the plurality of first stacked capacitors 11A are sequentially stacked on a top end of a lead frame electrode pins (that is, on a top end of a buried portion of the second electrode structure 34), and the plurality of positive parts P of the plurality of second stacked capacitors 11B are sequentially stacked on a bottom end of the lead frame electrode pins (that is, on a bottom end of the buried portion of the second electrode structure 34). However, the present disclosure is not limited thereto.

It should be noted that the first electrode structure 31 of the electrode unit 3 of the fourteenth embodiment may be replaced with the first electrode structure 31 of the same electrode unit 3 as the second embodiment.

In conclusion, one of the beneficial effects of the present disclosure is that, the stacked capacitor assembly structure Z provided by the present disclosure has the technical features of “the first electrode structure 31 acts as the outer end electrode to cover one end of the capacitor unit 1 and electrically contacts one of the positive parts P and the negative parts N of the stacked capacitor 11” to effectively improve the production efficiency of the stacked capacitor assembly structure Z.

Thereby, the first electrode structure 31 as the outer end electrode can be used to cover the first portion 101 or the second portion 102 of the stacked capacitor 11 (that is, the first electrode structure 31 does not need to be inserted into an interior of the insulating package body 20 like electrode pins of the lead frame), so that the first electrode structure 31 of the electrode unit 3 can be quickly formed on the side end portion of the insulating package body 20 without performing any bending step (step of bending the electrode pins of the lead frame). Thereby, a production efficiency of the stacked capacitor assembly structure Z is effectively improved. However, the present disclosure is not limited thereto.

It should be noted that the insulating package body 20 shown in FIG. 5 to FIG. 18 is only one example of the present disclosure, in other embodiments of the present disclosure, the insulating package body 20 can be omitted, and the capacitor unit 1 and the electrode unit 3 can be directly adopted.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A stacked capacitor assembly structure, comprising:
a capacitor unit including a plurality of stacked capacitors, wherein each of the stacked capacitors has a positive part and a negative part;
a package unit including an insulating package body partially covering the capacitor unit, wherein the capacitor unit has a first portion and a second portion exposed from the package unit; and
an electrode unit including a first electrode structure and a second electrode structure;
wherein each of the stacked capacitors includes a metal foil, the surface of the metal foil has a porous corrosion layer, and the porous corrosion layer is at least divided into a first porous corrosion region belonging to the positive part and a second porous corrosion region belonging to the negative part;
wherein the capacitor unit includes a plurality of insulating fillers, and each of the insulating fillers is surroundingly filled around the corresponding first porous corrosion region to block water vapor from passing through the first porous corrosion region.

2. The stacked capacitor assembly structure according to claim 1, wherein the plurality of the stacked capacitors are sequentially stacked, the stacked capacitors are electrically connected to each other by a conductive adhesive, and the plurality of positive parts of the plurality of stacked capacitors are sequentially stacked or separated from each other; wherein the first electrode structure serves as a first outer end electrode to cover the first portion of the capacitor unit and electrically contacts the positive part of the stacked capacitor; wherein the second electrode structure serves as a second outer end electrode to cover the second portion of the capacitor unit and electrically contacts the negative part of the stacked capacitor;
wherein the insulating filler is an epoxy resin, a phenolic resin or a silicone resin.

3. The stacked capacitor assembly structure according to claim 1, further comprising: a support unit including a first support member and a second support member, and the plurality of stacked capacitors are sequentially stacked on the first support member and the second support member, wherein the positive part of the stacked capacitor and the negative part are electrically connected to the first support member and the second support member, respectively.

4. The stacked capacitor assembly structure according to claim 1, further comprising: a support unit including a first support member, and the plurality of stacked capacitors sequentially stacked on the first support member, wherein the positive part or the negative part of the stacked capacitor is electrically connected to the first support member.

5. The stacked capacitor assembly structure according to claim 4, wherein the first electrode structure includes a first inner conductive layer covering the first portion and electrically contacting the positive part, a first intermediate conductive layer covering the first inner conductive layer, and a first outer conductive layer covering the first intermediate conductive layer.

6. The stacked capacitor assembly structure according to claim 5, wherein the second electrode structure includes a second inner conductive layer covering the second portion and electrically contacting the negative part, a second intermediate conductive layer covering the second inner conductive layer, and a second outer conductive layer covering the second intermediate conductive layer; wherein the first electrode structure includes a conductive water resistance layer connected to the plurality of the positive parts and the plurality of the insulating fillers, and the conductive water resistance layer is made of a metal material or a metal compound, the metal material being gold (Au), silver (Ag), platinum (Pt), palladium (Pd), titanium (Ti), copper (Cu), and nickel (Ni), chromium (Cr), brass or zinc (Zn), and the metal compound being nickel-chromium alloy (NiCr), titanium tungsten (TiW), titanium nitride (TiNx), titanium carbide (TiC), titanium oxide (TiOx), titanium oxynitride (Ti(O,N)x), titanium oxynitride (Ti(O,C)x), titanium oxynitride (Ti(C,N)x) or titanium oxynitride (Ti(O,N,C)x).

7. A stacked capacitor assembly structure, comprising:
a capacitor unit including a plurality of stacked capacitors, wherein each of the stacked capacitors has a positive part and a negative part;
a package unit including an insulating package body partially covering the capacitor unit; and
an electrode unit including a first electrode structure and a second electrode structure;
wherein each of the stacked capacitors includes a metal foil, the surface of the metal foil has a porous corrosion layer, and the porous corrosion layer is at least divided into a first porous corrosion region belonging to the positive part and a second porous corrosion region belonging to the negative part;
wherein the capacitor unit includes a plurality of insulating fillers, and each of the insulating fillers is surroundingly filled around the corresponding first porous corrosion region.

8. The stacked capacitor assembly structure according to claim 7, wherein the first electrode structure includes a conductive water resistance layer connected to the plurality of the positive part and the plurality of the insulating fillers, and the conductive water resistance layer is made of a metal material or a metal compound, the metal material being gold (Au), silver (Ag), platinum (Pt), palladium (Pd), titanium (Ti), and nickel (Ni), chromium (Cr), brass or zinc (Zn), and the metal compound being nickel-chromium alloy (NiCr), titanium tungsten (TiW), titanium nitride (TiNx), titanium carbide (TiC), titanium oxide (TiOx), titanium oxynitride (Ti(O,N)x), titanium oxynitride (Ti(O,C)x), titanium oxynitride (Ti(C,N)x) or titanium oxynitride (Ti(O,N,C)x).

9. A stacked capacitor assembly structure, comprising:
a capacitor unit including a plurality of stacked capacitors, wherein each of the stacked capacitors has a positive part and a negative part; and
an electrode unit including a first electrode structure and a second electrode structure;
wherein each of the stacked capacitors includes a metal foil, the surface of the metal foil has a porous corrosion layer, and the porous corrosion layer is at least divided into a first porous corrosion region belonging to the positive part and a second porous corrosion region belonging to the negative part;
wherein the capacitor unit includes a plurality of insulating fillers, and each of the insulating fillers is surroundingly filled around the corresponding first porous corrosion region.

10. The stacked capacitor assembly structure according to claim 9, further comprising: a support unit including a first support member, the plurality of stacked capacitors being sequentially stacked on the first support member, wherein the positive part of the stacked capacitor and the negative part are electrically connected to the first support member;
wherein the first electrode structure serves as a first outer end electrode to cover one end of the capacitor unit and electrically contact one of the positive part and the negative part of the stacked capacitor; wherein the second electrode structure is electrically connected to another one of the positive part and the negative part of the stacked capacitor; wherein the first electrode structure includes a conductive water resistance layer connected to the plurality of the positive part and the plurality of the insulating fillers, and the conductive water resistance layer is made of a metal material or a metal compound, the metal material being gold (Au), silver (Ag), platinum (Pt), palladium (Pd), titanium (Ti), copper (Cu), and nickel (Ni) , chromium (Cr), brass or zinc (Zn), and the metal compound being nickel-chromium alloy (NiCr), titanium tungsten (TiW), titanium nitride (TiNx), titanium carbide (TiC), titanium oxide (TiOx), titanium oxynitride (Ti(O,N)x), titanium oxynitride (Ti(O,C)x), titanium oxynitride (Ti(C,N)x) or titanium oxynitride (Ti(O,N,C)x).
